(19) United States
(12) Patent Application Publication
(10) Pub. No.: US 2012/0060411 A1
(43) Pub. Date: Mar. 15, 2012

(54) MOBILE BIODIESEL PRODUCTION FACILITY

(76) Inventors: Martin Allan Morris, Monticello, IL (US); Tony Khan, Champaign, IL (US); Michael J. Henneman, Champaign, IL (US); Jim Vollrath, Champaign, IL (US)

(21) Appl. No.: 13/147,263

(22) PCT Filed: Feb. 10, 2010
(86) PCT No.: PCT/US10/23720

§ 371 Date: Nov. 7, 2011

Related U.S. Application Data
(62) Division of application No. 61/151,325, filed on Feb. 10, 2009.

(51) Int. Cl. C10L 1/19; B01J 19/00

(52) U.S. Cl. 44/388; 422/187

(57) ABSTRACT

A mobile biodiesel production facility comprising a shear mixer, a centrifuge, a control unit, and a plurality of pumps needed to pump the feedstocks and reactants. Upon mixing, the feedstock and reactant mixture becomes a reaction product. A residence tank collects the reaction product, where it rests for some time and self-converts to a residence product. The residence product is then pumped to the centrifuge, where the centrifuge separates the residence product into biodiesel and a heavy phase product. The control unit coordinates the operations of the shear mixer, centrifuge, and plurality of pumps.

### CROSS-REFERENCE TO RELATED APPLICATIONS

This application claims the benefit of priority to U.S. Provisional Patent Application Ser. No. 61/151,325 filed Feb. 10, 2009, which is incorporated herein by reference in its entirety.

### BACKGROUND

The present invention relates to mobile facilities for the production of biofuels, especially the production of alkyl esters (“biodiesel”) which can be combusted independently or blended with petroleum diesel. Such biodiesel may be used in cars, trucks, trains, boats, ships, construction equipment, and generators. Mobile production facilities allow feedstocks to be converted to biofuels at or near to the point of production of the feedstocks, thus removing the costs associated with transporting the feedstock to a fixed refinery. Mobile facilities are especially economical when the biodiesel will be consumed near the point of production of the feedstocks. For example, a co-operative soybean crush facility may convert soybean oil to biodiesel, and that biodiesel may be sold to members of the co-operative who will use the biodiesel to power farm equipment.

### SUMMARY

The invention provides, among other things, an automated, mobile biodiesel production facility comprising a shear mixer operatively connected to a feedstock feed pump, a reactant feed pump, and a residence vessel; a centrifuge operatively connected to a centrifuge pump, the centrifuge pump operatively connected to the residence vessel, and a control unit. The feedstock feed pump is capable of pumping a feedstock from a feedstock container to the shear mixer. The reactant feed pump is capable of pumping a reactant from a reactant container to the shear mixer. The shear mixer is capable of mixing the feedstock and the reactant to create a reaction product. The residence vessel is capable of holding the reaction product while it self-converts to a residence product. The centrifuge feed pump is capable of pumping the residence product from the residence vessel to the centrifuge. The centrifuge is capable of separating a biodiesel and a heavy-phase product from the residence product. The control unit is capable of controlling the shear mixer, the centrifuge, the feedstock feed pump, the reactant feed pump, and the centrifuge feed pump to create the biodiesel and the heavy phase product from the feedstock and the reactant.

The invention additionally provides, among other things, a method of producing biodiesel and a heavy-phase product in a mobile biodiesel production facility comprising mixing a feedstock and a reactant to create a reaction product; holding the reaction product in a residence vessel while it self-converts to a residence product; and separating the biodiesel and the heavy-phase product from the residence product. In some embodiments, the method further comprises pumping a feedstock from a feedstock container to the shear mixer and pumping a reactant from a reactant container to the shear mixer. In some embodiments, the mixing is done with a shear mixer. In some embodiments, the separating is done with a centrifuge.

### BRIEF DESCRIPTION OF THE DRAWINGS

FIG. 1 is an exterior view of a mobile biodiesel production facility according to the invention.

FIG. 2 is another exterior view of a mobile biodiesel production facility according to the invention.

FIG. 3 is a cut-away overhead view of a mobile biodiesel production facility according to the invention.

FIG. 4 is a cut-away side view of a mobile biodiesel production facility according to the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The invention provides a mobile biodiesel production facility. In one embodiment the automated, mobile biodiesel production facility comprises a shear mixer, a centrifuge, a control unit, and a plurality of pumps needed to pump the feedstocks and reactants. The shear mixer is fed feedstock and reactant by a feedstock feed pump, and a reactant feed pump, respectively. Upon mixing, the feedstock and reactant mixture becomes a reaction product. A residence tank collects the reaction product, where it rests for some time and self-converts to a residence product. The residence product is then pumped to the centrifuge, where the centrifuge separates the residence mixture into biodiesel and a heavy phase product. The control unit coordinates the operations of the shear mixer, centrifuge, and plurality of pumps.

The invention additionally provides a method for the creation of a biodiesel product with a mobile biodiesel production facility. A feedstock is pulled from a feedstock source with a feedstock feed pump. A reactant is pulled from a reactant source with a reactant feed pump. The feedstock and the reactant are combined in a 4:1 ratio with a shear mixer to make a reaction product. The reaction product is collected in a residence vessel where it is allowed to sit for some time and self-convert to a residence product. The residence product is then pumped to the centrifuge, where the centrifuge separates the residence mixture into biodiesel and a heavy phase product.

In particular, the invention allows for the efficient conversion of feedstocks to alkyl esters which are suitable to be used as fuels and fuel additives. Feedstocks suitable for the invention include, but are not limited to, plant oils, animal fats, animal tallow, grease, and algae. In particular, plant oils such as those derived from soy, corn, canola (rapeseed), jatropha, cotton, sunflowers, pongamia, mangos, and palm are suitable for use with the invention. Animal fats suitable for the invention include fats, lards, and tallows from cattle, swine, chickens, turkey, fish, and whales. Algae oil is also suitable for use with the invention, provided the algae oil is dry. Oils that are naturally high in triglycerides (such as soy) are favored, however animal fats or other feedstocks with higher free fatty acids are suitable for the invention after pre-treatment to remove a portion of the free fatty acids.

Alkyl esters according to the invention typically comprise esters of long chain hydrocarbons wherein the carbon chain is six to twenty-six carbons in length. Alkyl esters produced for fuel are also referred to as fatty acid alkyl esters, or specifically fatty acid methyl esters (FAME), when the alkyl group is a methyl group. The alkyl group attached to the alkyl ester is typically small, such as a methyl or an ethyl group, however larger esters may be formed with the invention, such as propyl and butyl esters. A blend of alkyl esters meeting ASTM standard D6751 can be sold in the United States as biodiesel or B100. Essentially pure biodiesel (e.g., alkyl esters plus preservatives) may be sold as B100, or the biodiesel may be blended with petroleum diesel to make grades such as B99, B90, B20, B10, etc.

Mobile biodiesel production facilities of the invention may produce up to 14,000 U.S. gallons of biodiesel in 24 hours, however faster production rates are possible with larger pumps and centrifuges than those described herein. Additionally, by using smaller pumps and centrifuges, a mobile biodiesel production facility can be constructed that will produce 5,000 U.S. gallons of biodiesel in 24 hours. The mobile facility described herein has the ability to produce biodiesel at these rates without the need for additional power as the mobile facility includes its own generator which may burn some of the biodiesel product produced by the facility.

The production efficiency achievable by the invention is partly due to the use of a reactant formulation comprising a mixture of lower alcohols, ketones, acetates, and alkaline hydroxide. The reactant formulation typically comprises about 90%-97% ethanol, about 3-6% methanol, about 1-3% ketones, about 1-3% ethyl acetate, and about less than 10% (w/w) alkaline hydroxide. Ketones suitable for the invention include, but are not limited to, acetone, methyl ethyl ketone, and methyl isobutyl ketone. Alkaline hydroxides suitable for the reaction include, but are not limited to, sodium hydroxide, calcium hydroxide, and potassium hydroxide. The reactant formulation is further described in co-pending U.S. patent application Ser. No. 12/275,736, and PCT Application PCT/US09/064946, both of which are incorporated herein by reference in their entirety.

The reactant is combined with the feedstock in about a 1:4 (v/v) ratio of reactant to feedstock. When this reactant formulation is used with the facility described herein, there is no need to provide additional heat or pressure to the feedstocks, reactants, or reaction mixtures in order to achieve biodiesel. The invention provides the further benefit of producing less heavy-phase product than about 5% (w/w) of the sum of the feedstock and reactant mixture, more typically less than about 2% (w/w) of the sum of the feedstock and reactant mixture, optimally less than about 1% (w/w) of the sum of the feedstock and reactant mixture. The heavy phase product primarily contains glycerin (glycerol) and alkaline salts. Thus, for each 4 gallons of feedstock mixed with 1 gallon of reactant, only about 0.1 gallons of heavy phase product is produced. The remaining volume is biodiesel product. The biodiesel product comprises mostly alkyl esters. The biodiesel product may also contain small quantities of lower alcohols, such as ethanol and methanol.

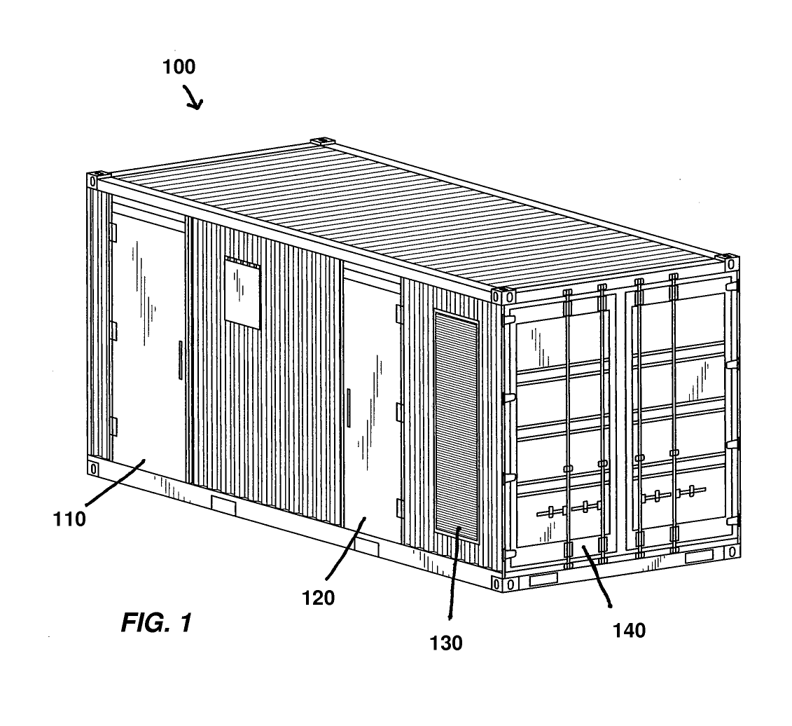

The exterior of a mobile biodiesel production facility 100 is shown in FIG. 1. The exterior is identical in size to a standard ISO shipping container. Such containers are commonly used to move goods around the globe via ship, train, truck, etc. Mobile biodiesel production facility 100 has a reactor access door 110, a control room access door 120, louvers for generator ventilation 130, and generator access doors 140.

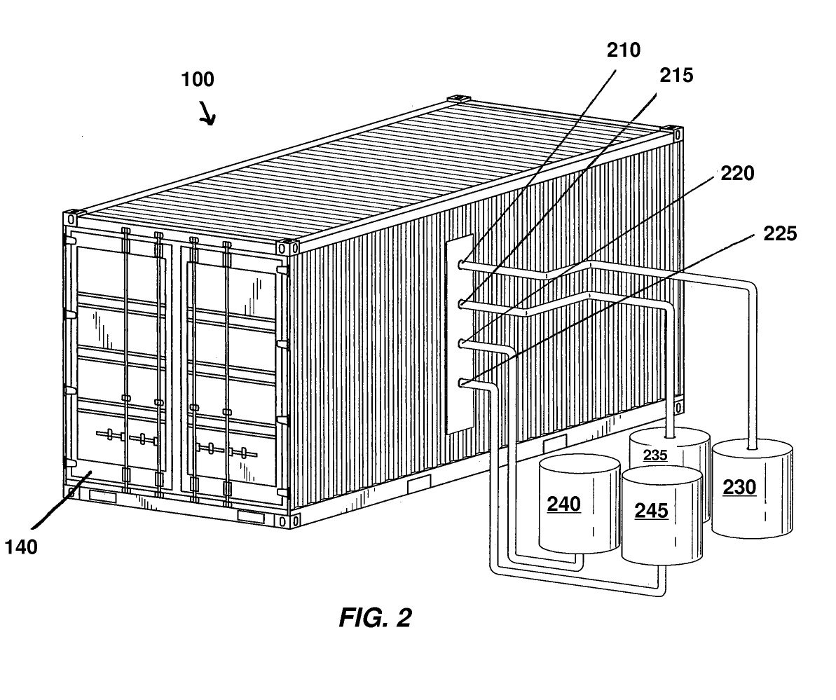

Another side of mobile biodiesel production facility 100 is shown in FIG. 2. Mobile biodiesel production facility 100 has a heavy phase output port 210, a biodiesel output port 215, a reactant input port 220, and a feedstock input port 225. While not part of the invention, a heavy phase recovery tank 230, a biodiesel recovery tank 235, a reactant supply tank 240, and a feedstock supply tank 245 are shown for illustrative purposes. Tanks 230, 235, 240, and 245 may be any shape or size. Reactant supply tank 240 and feedstock supply tank 245 may optionally have heating elements to allow the feedstock and reactant temperatures to be maintained around 50° F.

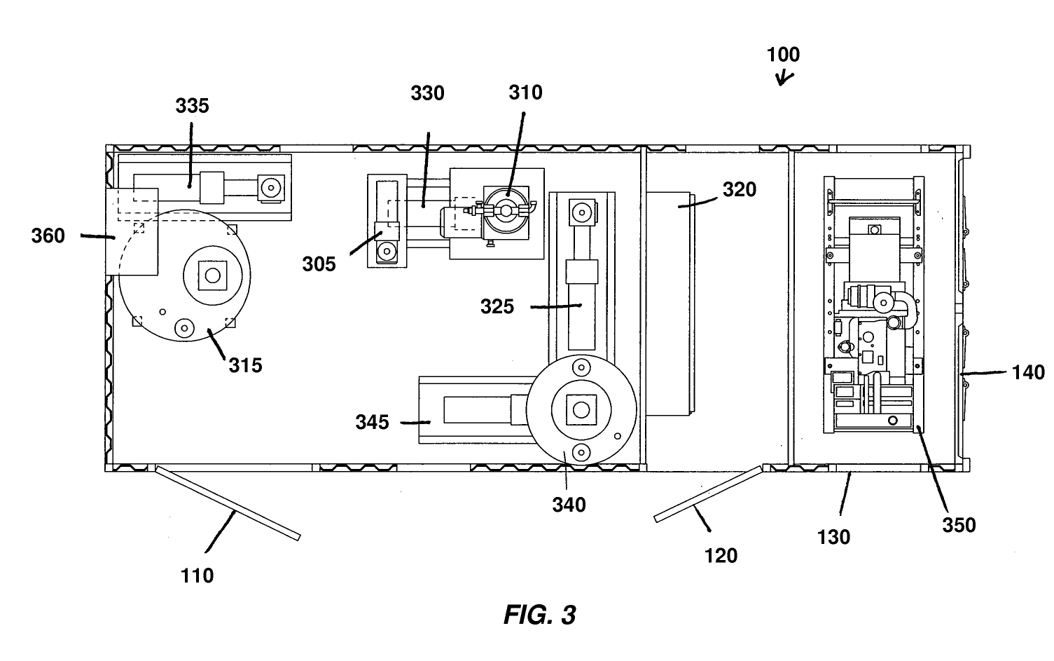

An overhead cut-away view of mobile biodiesel production facility 100 is shown in FIG. 3. Mobile biodiesel production facility 100 comprises a shear mixer 305, a centrifuge 310, a residence vessel 315 and a control unit 320. A feedstock feed pump 325 pulls feedstock into mobile biodiesel production facility 100, while a reactant feed pump 330 pulls reactants into mobile biodiesel production facility 100. The feedstock and reactant are mixed in shear mixer 305 to make a reaction product. The mixing is typically instantaneous as the feedstock and the reactant pass through shear mixer 305. Upon exiting shear mixer 305, the reaction product is collected in residence vessel 315. Typically there is no need for a separate pump between shear mixer 305 and residence vessel 315, although an additional pump could be inserted between shear mixer 305 and residence vessel 315.

Shear mixers 305 suitable for the invention may be obtained from Silverson Machines, Inc. (Longmeadow, Mass.), and typically have throughputs on the order of 1,000 gal/hr, however, higher- or lower-throughput shear mixers may be suitable for use with the invention. Other mixers capable of intimately blending the feedstock and reactant may be suitable. For example, a cavitation reactor may be used to blend the feedstock and reactant. Cavitation reactors suitable for the invention may be obtained from Hydro Dynamics, Inc. (Rome, Ga.).

The reaction product collected in residence vessel 315 is allowed to rest for some time, whereupon it self-converts to a residence product. The reaction product preferably resides for less than 60 minutes, more preferably less than 20 minutes, most preferably less than 10 minutes. Residence vessel 315 is typically constructed from a plastic that will not react with the reaction product, including, but not limited to Teflon, polypropylene, polyethylene, and ABS. Residence vessel 315 is typically at least 50 gallons, more typically at least 100 gallons, more typically at least 300 gallons. Any suitable non-reactive container may be used as residence vessel 315. Such suitable residence vessels 315 include those manufactured by ChemIndustrial Systems, Inc. (Cedarburg, Wis.). In some embodiments, it may be beneficial to use multiple residence vessels 315 to allow for higher throughputs for mobile biodiesel production facility 100.

After the reaction product has been allowed to rest and self-convert to a residence product, the residence product is pumped with centrifuge feed pump 335 from residence vessel 315 to centrifuge 310, where the residence product is separated into a biodiesel product and a heavy phase product. The biodiesel product typically exits the mobile biodiesel production facility 100 via biodiesel output port 215 immediately upon separation from the reaction product in centrifuge 310. Centrifuges suitable for the invention may be obtained from Seital Separatori (Vicenza, Italy), for example. Centrifuges suitable for the invention typically have a throughput of 5 gal/min, more typically 10 gal/minute, most typically 20 gal/minute. Other known methods for the separation of liquid mixtures may be used. Optionally, a biodiesel output pump (not shown in FIG. 3) may be used to pull biodiesel from centrifuge 310 for collection outside of mobile biodiesel production facility 100. The heavy phase product is typically collected in a heavy phase receiver 340 until there is enough heavy phase product collected to run heavy phase feed pump 345 to push the heavy phase product outside of mobile biodiesel production facility 100 for collection. Heavy phase receiver 340 is also made of non-reactive plastic. Any suitable non-reactive container may be used as heavy phase receiver 340. Such suitable heavy phase receiver 340 include those manufactured by ChemIndustrial Systems, Inc. (Cedarburg, Wis.).

A variety of fluid pumps may be suitable for incorporation into a mobile biodiesel production facility of the invention. Such pumps include, but need not be limited to, those manufactured by Viking Pump (Cedar Falls, Iowa). Throughputs suitable for the invention are greater than 0.1 gallons per minute, typically greater than 1 gallon per minute, more typically greater than 10 gallons per minute.

The production of biodiesel is coordinated by control unit 320, which is capable of controlling the operation of shear mixer 305, centrifuge 310, and feed pumps, 325, 330, 335, and 345. Control unit 320 is also capable of actuating various solenoid valves and relays (not shown) necessary to perform the production process. Control unit 320 additionally monitors pressure sensors, flow meters, and thermocouples (not shown) integrated into mobile biodiesel production facility 100. Control unit 320 comprises a display, a user interface, a microprocessor, and a modbus communications hub (not shown). Such control units may be purchased directly or assembled from known components. Control units suitable for the invention are available from Springfield Electric (Springfield, Ill.).

As shown in FIG. 3, mobile biodiesel production facility 100 additionally contains a diesel generator 350 and exhaust fan 360. Diesel generator 350 may be obtained from any of a number of diesel generator manufacturers, including, but not limited to Caterpillar Inc. (Peoria, Ill.). Exhaust fan 360 is available from known exhaust fan manufacturers. Diesel generator 350 will typically provide sufficient electrical output to power control unit 320, shear mixer 305, centrifuge 310, and feed pumps, 325, 330, 335, and 345, in addition to ancillary valves, lighting, heating, etc. Diesel generator 350 will typically be less than or equal to 50 kW, more typically less than or equal to 25 kW, most typically less than or equal to 10 kW.

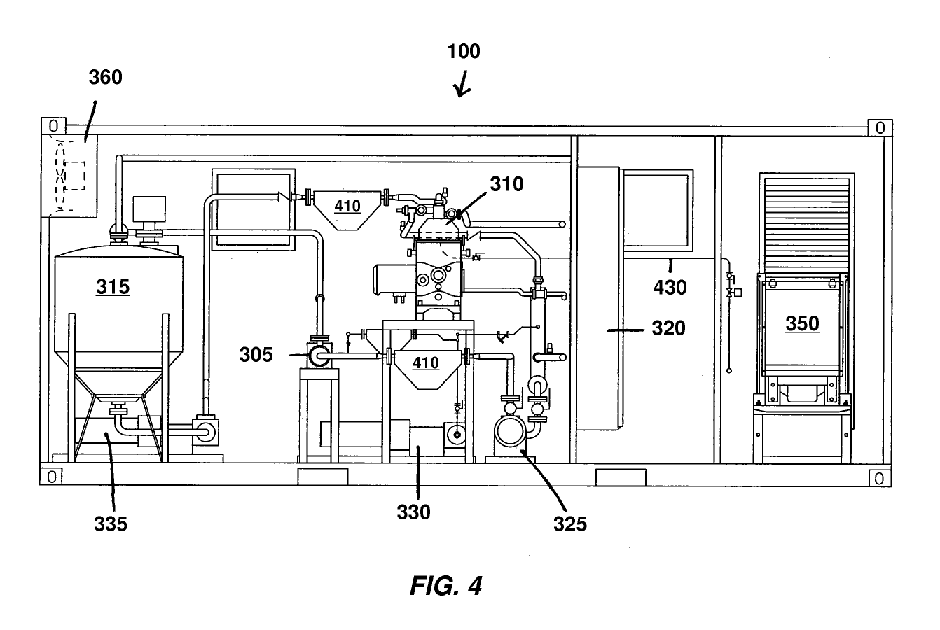

As shown in FIG. 4, diesel generator 350 may be supplied by biodiesel product off-take 430, to allow mobile biodiesel production facility 100 to operate completely self-sufficiently. Self-sufficient operation will typically be used when mobile biodiesel production facility 100 is located in an area lacking reliable electrical supply, such as on a farm, at a quayside, or at a tree-oil plantation. In the event that reliable electrical supply is available, power control unit 320, shear mixer 305, centrifuge 310, and feed pumps, 325, 330, 335, and 345, etc. may be powered through a normal electrical circuit breaker (not shown). In some embodiments, diesel generator 350 may have greater than 50 kW capacity. The excess electrical capacity could be used for powering additional equipment such as oil extraction equipment.

Optionally, in-line strainers 410 and filters (not shown) may also be added to mobile biodiesel production facility 100 to assure that various contaminants are removed from the feedstock, reactant, reaction product, biodiesel or heavy-phase product. In-line strainers may be screen strainers or particle filters. Strainers suitable for the invention are available from Eaton Filtration, LLC (Elizabeth, N.J.).

Thus, the invention provides, among other things, an automated, mobile biodiesel production facility. Additional advantages will be realized by those of skill in the art in view of the examples and claims below.

### EXAMPLE 1

### High Efficiency Conversion of Refined Soybean Oil to Biodiesel

Using a mobile biodiesel production facility such as that shown in FIGS. 1-4, 100 gallons of a soybean oil and reactant mixture is converted into 98 gallons of biodiesel product. The entire process is run at ambient temperature (20° C.) and ambient pressure (760 mm Hg). Refined soybean oil was pumped from a soybean oil holding tank with a Viking 7.5 gal/min pump powered by a 1.5 HP electric motor. Reactant (88% ethanol, 5% methanol, 1% ethyl acetate, 1% methyl isobutyl ketone, and 5% potassium hydroxide (w/w)) was pumped from a reactant holding tank with a Viking 2.35 gal/min pump powered by a 1 HP electric motor. The soybean oil and reactant were mixed in a Silverson 10 gal/min shear mixer to produce a reaction product. The overall reaction rate was 10 gal/min. The pumps and shear mixer were run for approximately 10 minutes to produce 100 gallons of reaction product.

The 100 gallons of reaction product were collected in a 150 gallon high-density polypropylene residence vessel. The reaction product was allowed to sit for 20 minutes without additional mixing. After 20 minutes of residence, the 100 gallons of reaction product was pumped with a Viking 10 gal/min pump to a Seital 10 gal/min centrifuge, which separated the reaction product into biodiesel product and heavy phase product. The process produced 2 gallons of heavy phase product and 98 gallons of biodiesel product. The heavy phase product was collected in the heavy phase receiver. The biodiesel product was collected into a biodiesel product collection tank. The resultant biodiesel product was washed by spraying approximately 300 gallons of warm softened water across the biodiesel product. After two hours, the water was removed from the bottom of the product collection tank. The washed biodiesel product was next heated to approximately 250° F. to drive off any remaining water. The resultant washed and dried biodiesel product is an alkyl ester mixture that meets ASTM D6751 specifications. Independent laboratory tests for the alkyl ester mixture are shown in Table 1.

TABLE 1
ASTM D6751 analysis of biodiesel produced
with mobile production facility.

| TEST | RESULT | UNITS |
|---|---|---|
| Flash Point PMCC | 153 | ° C. |
| Water and Sediment | 0.010 | % Vol/Vol |
| Acid Number | 0.17 | mg KOH/g |
| Free Glycerin | <0.005 | WT % |
| Monoglycerides | 0.211 | WT % |
| Diglycerides | 0.330 | WT % |
| Triglycerides | 0.234 | WT % |
| Total Glycerin | 0.129 | WT % |
| Kinematic Viscosity at 40° C. | 4.222 | cst |
| Sulfated Ash | 0.0024 | % mass |
| Sulfur Content | 0.0001 | % mass |
| Copper Corrosion | 1A | none |
| Cetane Number | 48.2 | none |
| Cloud Point | −1 | ° C. |
| Carbon Residue | 0.019 | % mass |
| Phosphorous Content | <0.0010 | % mass |
| Sodium | 2.7 | PPM |
| Potassium | <0.1 | PPM |
| Calcium | 0.1 | PPM |
| Magnesium | 0.7 | PPM |
| Boiling Point Range | 328-362 | ° C. |
| Oxidation Stability Reduction | 2.4 | hours |
| Period | | |

1. An automated, mobile biodiesel production facility comprising:
a shear mixer operatively connected to a feedstock feed pump, a reactant feed pump, and a residence vessel;
a centrifuge operatively connected to a centrifuge pump, the centrifuge pump operatively connected to the residence vessel; and
a control unit;
the feedstock feed pump being capable of pumping a feedstock from a feedstock container to the shear mixer;
the reactant feed pump being capable of pumping a reactant from a reactant container to the shear mixer;
the shear mixer being capable of mixing the feedstock and the reactant to create a reaction product;
the residence vessel being capable of holding the reaction product while it self-converts to a residence product;
the centrifuge feed pump being capable of pumping the residence product from the residence vessel to the centrifuge;
the centrifuge being capable of separating a biodiesel and a heavy-phase product from the residence product; and
the control unit being capable of controlling the shear mixer, the centrifuge, the feedstock feed pump, the reactant feed pump, and the centrifuge feed pump to create the biodiesel and the heavy phase product from the feedstock and the reactant.

2. The automated, mobile biodiesel production facility of claim 1, wherein the heavy phase product comprises less than 5% (w/w) of the sum of the feedstock and the reactant mixture.

3. The automated, mobile biodiesel production facility of claim 2, wherein the heavy phase product comprises less than 2% (w/w) of the sum of the feedstock and the reactant mixture.

4. The automated, mobile biodiesel production facility of claim 1, further comprising a generator, the generator being operatively connected to provide electricity to power the shear mixer, the centrifuge, the feedstock feed pump, the reactant feed pump, the centrifuge feed pump, and the control unit.

5. The automated, mobile biodiesel production facility of claim 4, wherein the generator further comprises a fuel tank, the fuel tank being operatively connected to the centrifuge, and wherein the generator is powered by the biodiesel separated from the residence product by the centrifuge.

6. The automated, mobile biodiesel production facility of claim 1, wherein the automated, mobile biodiesel production facility is capable of producing about 5,000 U.S. gallons of biodiesel in 24 hours.

7. The automated, mobile biodiesel production facility of claim 6, wherein the automated, mobile biodiesel production facility is capable of producing about 14,000 U.S. gallons of biodiesel in 24 hours.

8. The automated, mobile biodiesel production facility of claim 1, wherein the reaction product self-converts to a residence product at ambient pressure.

9. The automated, mobile biodiesel production facility of claim 1, wherein the reaction product self-converts to a residence product at ambient temperature.

10. The automated, mobile biodiesel production facility of claim 1, further comprising a resistive heater operatively connected to the residence vessel and a source of electric power.

11. The automated, mobile biodiesel production facility of claim 1, wherein the feedstock is selected from the group consisting of plant oils, animal fats, animal tallow, grease, and algae oil.

12. The automated, mobile biodiesel production facility of claim 1, wherein the biodiesel comprises alkyl esters selected from the group consisting of methyl esters, ethyl esters, and propyl esters.

13. The automated, mobile biodiesel production facility of claim 1, wherein the facility is contained in a 20 ft. ISO shipping container.

14. The automated, mobile biodiesel production facility of claim 1, wherein the residence vessel is at least about 100 U.S. gallons in capacity.

15. The automated, mobile biodiesel production facility of claim 14, wherein the residence vessel is at least about 300 U.S. gallons in capacity.

16. A method of producing biodiesel and a heavy-phase product in a mobile biodiesel production facility comprising:
a) mixing a feedstock and a reactant to create a reaction product;
b) holding the reaction product in a residence vessel while it self-converts to a residence product; and
c) separating the biodiesel and the heavy-phase product from the residence product.

17. The method of claim 16, further comprising pumping a feedstock from a feedstock container to the shear mixer and pumping a reactant from a reactant container to the shear mixer.

18. The method of claim 16, wherein mixing is done with a shear mixer.

19. The method of claim 16, wherein separating is done with a centrifuge.

20. The method of claim 16, wherein the heavy phase product comprises less than 5% (w/w) of the sum of the feedstock and the reactant.

21. The method of claim 20, wherein the heavy phase product comprises less than 2% (w/w) of the sum of the feedstock and the reactant.

22. The method of claim 16, wherein about 5,000 U.S. gallons of biodiesel is separated in 24 hours.

23. The method of claim 22, wherein about 14,000 U.S. gallons of biodiesel is separated in 24 hours.

24. The method of claim 16, wherein holding takes place at ambient pressure.

25. The method of claim 16, wherein holding takes place at ambient temperature.

26. The method of claim 16, wherein holding lasts less than about 60 minutes.

27. The method of claim 26, wherein holding lasts less than about 20 minutes.

28. The method of claim 16, wherein the feedstock is selected from the group consisting of plant oils, animal fats, animal tallow, grease, and algae oil.

29. The method of claim 16, wherein the reactant comprises about 90%-97% ethanol, about 3-6% methanol, about 1-3% ketones, about 1-3% ethyl acetate, and less than about 10% (w/w) alkaline hydroxide.

30. The method of claim 16, wherein the feedstock and the reactant are mixed at a ratio of about 4:1 (v/v, feedstock:reactant).

31.-49. (canceled)
